(19) United States
(12) Patent Application Publication
(10) Pub. No.: US 2025/0327319 A1
(43) Pub. Date: Oct. 23, 2025

(54) CONCRETE DISTRIBUTING BOOM, CONCRETE PUMPING EQUIPMENT AND METHOD AND EQUIPMENT FOR MANUFACTURING CONCRETE DISTRIBUTING BOOM BRACKET

(71) Applicants: JIANGSU XCMG CONSTRUCTION MACHINERY RESEARCH INSTITUTE LTD., Xuzhou, Jiangsu (CN); XUZHOU XCMG SCHWING MACHINERY CO. LTD., XUZHOU, JIANGSU (CN)

(72) Inventors: Xiang ZHANG, XUZHOU (CN); Zhongyuan ZHANG, XUZHOU (CN); Haibo WANG, XUZHOU (CN)

(21) Appl. No.: 18/870,195

(22) PCT Filed: Mar. 14, 2023
(86) PCT No.: PCT/CN2023/081362

§ 371 Date: Nov. 27, 2024

(51) Int. Cl. E04G 21/04; B22D 13/00

(52) U.S. Cl. CPC E04G 21/0418; B22D 13/00

(57) ABSTRACT

The present disclosure provides a concrete distributing boom. The concrete distributing boom is provided with a bracket. The bracket is configured to support a hose at a tail end of a concrete conveying pipe (11). The bracket is formed by a multilayer composite tube made of at least two layers of aluminum alloy arranged in a stacked manner. The at least two layers of aluminum alloy include an outermost layer of aluminum alloy and an innermost layer of aluminum alloy. Of the at least two layers of aluminum alloy, the outermost layer of aluminum alloy is more resistant to abrasion, and the innermost layer of aluminum alloy is more rigid. The bracket of the present disclosure has improved abrasion-resistance and load-bearing property and a reduced weight, thereby improving the load-bearing property and the service life of the concrete distributing boom.

### FIELD OF THE INVENTION

The present disclosure relates to the field of concrete pumping, and in particular, to a concrete distributing boom, concrete pumping equipment, and a method and equipment for manufacturing a concrete distributing boom bracket.

### BACKGROUND OF THE INVENTION

Concrete pumping equipment uses a rubber tube or a hose at a tail end of a concrete conveying pipe to deliver concrete or other material. Especially a boom-type concrete pump truck needs a long-distance conveying pipe in order to convey a material to a high-rise building so as to perform an aerial concrete pouring operation. The higher the conveying height, the higher the price of concrete. Therefore, reducing the weight of a conveying mechanism is a way to increase the concrete conveying height and improve economic efficiency. Distributing boom brackets allow the conveying pipe to be supported on a distributing boom, and function to carry and support the conveying pipe. Moreover, a large number of distributing boom brackets are used and need to have high strength, toughness and rigidity. Since the hose located at the tail end of the conveying pipe needs to be taken down frequently, which accelerates abrasion on the bracket, the bracket needs to have good abrasion resistance.

At present, a bracket of a concrete distributing boom is usually formed by bending a tube of carbon steel or alloy steel, so the bracket has the characteristics of medium strength, high plasticity during cold deformation, good low-temperature performance, weldability and cuttability. Moreover, a steel bracket is suitable to be welded to a steel distributing boom. All steel brackets have the problem of a high weight and a limited conveying height.

In the case of using an aluminum alloy distributing boom in order to reduce the weight and increase the material conveying height, high-quality connection between the steel bracket and the aluminum alloy distributing boom cannot be implemented due to poor quality of welding between steel and aluminum. In addition, in the case of connection by threaded connectors or riveting pieces, the connection between the steel bracket and the aluminum alloy distributing boom cannot withstand high-frequency vibration impacts of the distributing boom. There is a potential difference at the connection between the bracket and the distributing boom which have different matrix metals, and thus electrochemical corrosion is liable to occur there, which causes damage to the matrix material of the distributing boom. If a bracket made of aluminum alloy only is used, the abrasion resistance and load-bearing performance of bracket are insufficient, which adversely affects the service life of the distributing boom. As the hose needs to be taken frequently during work, the surface of the steel bracket is subject to much abrasion. On the one hand, a surface coating on the steel bracket wears down, resulting in rusting of the steel bracket; on the other hand, the matrix material wears down, resulting in abrasion of the bracket and accelerating a failure, such that the bracket needs to be replaced frequently, and the customer experience is poor. A bracket made of ordinary aluminum alloy formed by welding has the disadvantages of low welding strength, insufficient load-bearing performance, and non-abrasion-resistance on the surface.

### SUMMARY OF THE INVENTION

In order to improve the above technical shortcomings, the present disclosure provides a concrete distributing boom, the concrete distributing boom being provided with a bracket, the bracket being configured to support a hose at a tail end of a concrete conveying pipe, the bracket being formed by a multilayer composite tube made of at least two layers of aluminum alloy arranged in a stacked manner; the at least two layers of aluminum alloy including an outermost layer of aluminum alloy and an innermost layer of aluminum alloy, wherein of the at least two layers of aluminum alloy, the outermost layer of aluminum alloy is more resistant to abrasion, and the innermost layer of aluminum alloy is more rigid.

In some embodiments of the present disclosure, the at least two layers of aluminum alloy further include an intermediate layer of aluminum alloy located between the innermost layer of aluminum alloy and the outermost layer of aluminum alloy, the intermediate layer of aluminum alloy having greater strength and toughness relative to the innermost layer of aluminum alloy and the outermost layer of aluminum alloy.

In some embodiments of the present disclosure, the innermost layer of aluminum alloy has a density less than that of the outermost layer of aluminum alloy, or the intermediate layer of aluminum alloy has a density less than that of the outermost layer of aluminum alloy but greater than that of the innermost layer of aluminum alloy.

In some embodiments of the present disclosure, the densities of the at least two layers of aluminum alloy decrease sequentially from outside to inside.

In some embodiments of the present disclosure, the concrete distributing boom is made of aluminum alloy and is integrally connected with the bracket.

In some embodiments of the present disclosure, the outermost layer of aluminum alloy contains abrasion-resistant reinforcing particles.

In some embodiments of the present disclosure, the abrasion-resistant reinforcing particles are distributed in the outermost layer of aluminum alloy in such a manner that their sizes progressively increase outwards along a radial direction.

In some embodiments of the present disclosure, the abrasion-resistant reinforcing particles are distributed in the outermost layer of aluminum alloy in a manner of distributing more densely on the outer side than on the inner side.

In some embodiments of the present disclosure, a combination of sizes of the abrasion-resistant reinforcing particles includes a first diameter ranging between 12-18 μm, a second diameter ranging between 24-36 μm, and a third diameter ranging between 40-60 μm.

In some embodiments of the present disclosure, the first diameter is 15 μm, the second diameter is 30 μm, and the third diameter is 50 μm.

The present disclosure provides concrete pumping equipment, including a stationary concrete pump or a mobile concrete pump truck, which includes a hose located at a tail end of a concrete conveying pipe, and the concrete distributing boom as described above.

The present disclosure provides a method for manufacturing a bracket of a concrete distributing boom, the bracket being configured to support a hose located at a tail end of a conveying pipe of concrete pumping equipment, wherein the method includes the following steps:
centrifugally casting a tube blank, including preparing a multilayer composite tube blank having at least two layers of alloy by a centrifugal casting process, the at least two layers of alloy including an outermost layer of aluminum alloy having high abrasion resistance and an innermost layer of aluminum alloy having high rigidity;
transferring the tube blank, including transferring the tube blank from a station for performing centrifugal casting to a station for performing rotary extrusion;
extrusion molding a bracket, including performing rotary extrusion on the tube blank to obtain the bracket; and
continuously performing the steps of centrifugally casting the tube blank, transferring the tube blank, and extrusion molding the bracket, successively.

In some embodiments of the present disclosure, the step of transferring the tube blank includes transferring the tube blank from the station for performing centrifugal casting to the station for performing rotary extrusion by moving a centrifugal casting die; in the station for performing centrifugal casting, the tube blank is centrifugally cast in a cavity of the centrifugal casting die; and in the station for performing rotary extrusion, the tube blank in the cavity of the centrifugal casting die is rotationally extruded.

In some embodiments of the present disclosure, the step of centrifugally casting the tube blank includes:
providing abrasion-resistant reinforcing particles of various sizes;
heating and melting an aluminum alloy matrix;
agitating the aluminum alloy matrix, and successively adding the abrasion-resistant reinforcing particles of various sizes, wherein a rotational speed of agitating the aluminum alloy matrix when small-size abrasion-resistant reinforcing particles are added is less than a rotational speed of agitating the aluminum alloy matrix when large-size abrasion-resistant reinforcing particles are added; and
pouring the aluminum alloy matrix with the abrasion-resistant reinforcing particles into a cavity of a centrifugal casting device, and preparing an outermost layer of aluminum alloy containing the abrasion-resistant reinforcing particles by a centrifugal casting process.

In some embodiments of the present disclosure, the various sizes of the abrasion-resistant reinforcing particles include a first diameter ranging between 12-18 μm, a second diameter ranging between 24-36 μm, and a third diameter ranging between 40-60 μm.

In some embodiments of the present disclosure, the first diameter is 15 μm, the second diameter is 30 μm, and the third diameter is 50 μm.

In some embodiments of the present disclosure, in the step of centrifugal casting the tube blank, once the preparation of the highly abrasion-resistant outermost layer of aluminum alloy is completed, melted aluminum alloy is poured into the cavity of the centrifugal casting device, and a second layer of aluminum alloy is cast on the inner side of the highly abrasion-resistant outermost layer of aluminum alloy by a centrifugal casting process, the second layer of aluminum alloy having higher rigidity or having higher strength and toughness than the outermost layer of aluminum alloy.

In some embodiments of the present disclosure, in the step of centrifugal casting the tube blank, once the preparation of the second layer of aluminum alloy with higher strength and toughness is completed, a melted high-rigidity alloy material is immediately poured into the cavity of the centrifugal casting device, and a third layer of aluminum alloy is cast on the inner side of the high-strength-and-toughness second layer of aluminum alloy by a centrifugal casting process, the third layer of aluminum alloy having higher rigidity than the highly abrasion-resistant outermost layer of aluminum alloy and the high-strength-and-toughness second layer of aluminum alloy.

In some embodiments of the present disclosure, in a radial direction of the tube blank, the densities of the layers of aluminum alloy decrease sequentially from outside to inside.

The present disclosure provides equipment for manufacturing a concrete distributing boom bracket, including:
a centrifugal casting device including a centrifugal casting die having a cavity therein; the
a rotary extrusion device configured to extrude a tube blank to form the bracket, and including an extrusion die mouth and a bracket forming die which are communicated with each other,
wherein the centrifugal casting die is movable to switch between a station for performing centrifugal casting and a station for performing rotary extrusion, wherein when the centrifugal casting die is located in the station for performing centrifugal casting, the tube blank having at least two layers of alloy is formed in the cavity of the centrifugal casting die by a centrifugal casting process, and when the centrifugal casting die is located in the station for performing rotary extrusion, the cavity of the centrifugal casting die is communicated with the extrusion die mouth, so that the tube blank in the cavity of the centrifugal casting die is rotationally extruded into the bracket forming die through the extrusion die mouth to form the bracket.

In some embodiments of the present disclosure, the equipment further includes a rail, the rail being located between the centrifugal casting device and the rotary extrusion device, the centrifugal casting die being movable along the rail to switch between the station for performing centrifugal casting and the station for performing rotary extrusion.

In some embodiments of the present disclosure, the rotary extrusion device includes a heating device for heating the rotary extrusion device.

In some embodiments of the present disclosure, the equipment further includes a controller, the controller being configured to receive operating status information of the centrifugal casting device and the rotary extrusion device and to send instructions directing the centrifugal casting device and rotary extrusion device to perform operations, and the controller being configured to perform at least one of the following operations:
in response to completing preparation of the tube blank having at least two layers of alloy, sending an instruction to drive the centrifugal casting die to move toward the station for performing rotary extrusion; and
in response to the centrifugal casting device arriving at the station for performing rotary extrusion, sending an instruction directing the rotary extrusion device to perform extrusion of the tube blank; and
in response to the end of extrusion of the tube blank by the rotary extrusion device, sending an instruction to drive the centrifugal casting die to move toward the station for performing centrifugal casting.

### BRIEF DESCRIPTION OF THE DRAWINGS

To more clearly describe technical solutions in the embodiments of the present disclosure or in the prior art, a brief introduction to the drawings for use in description of the embodiments or the prior art will be given below. Apparently, the drawings described below are only some embodiments of the present disclosure, and to those of ordinary skill in the art, other drawings may also be obtained based on these drawings without creative effort.

FIG. 1 shows a schematic diagram of concrete pumping equipment according to embodiments of the present disclosure;

FIG. 2 shows a partial schematic diagram of concrete pumping equipment according to embodiments of the present disclosure, in which a hose 15 located at a tail end of a concrete conveying pipe 11 is supported on a bracket 17 provided on a concrete distributing boom 12;

FIG. 3 shows a schematic diagram of a bracket 17 according to embodiments of the present disclosure;

FIG. 4 is a schematic cross-sectional diagram of an embodiment of the bracket 17 along A-A in FIG. 3;

FIG. 5 is a schematic cross-sectional diagram of another embodiment of the bracket 17 along A-A in FIG. 3;

FIG. 6 is an enlarged view of a region B in FIG. 4;

FIG. 7 shows equipment for manufacturing a distributing boom bracket 17 according to embodiments of the present disclosure, in which a centrifugal casting die 217 is in a station for performing centrifugal casting; and

FIG. 8 shows equipment for manufacturing a distributing boom bracket 17 according to embodiments of the present disclosure, in which a centrifugal casting die 217 is in a station for performing rotary extrusion.

### DETAILED DESCRIPTION OF THE EMBODIMENTS

Technical solutions in the embodiments of the present disclosure will be described in detail below in conjunction with the accompanying drawings in the embodiments of the present disclosure.

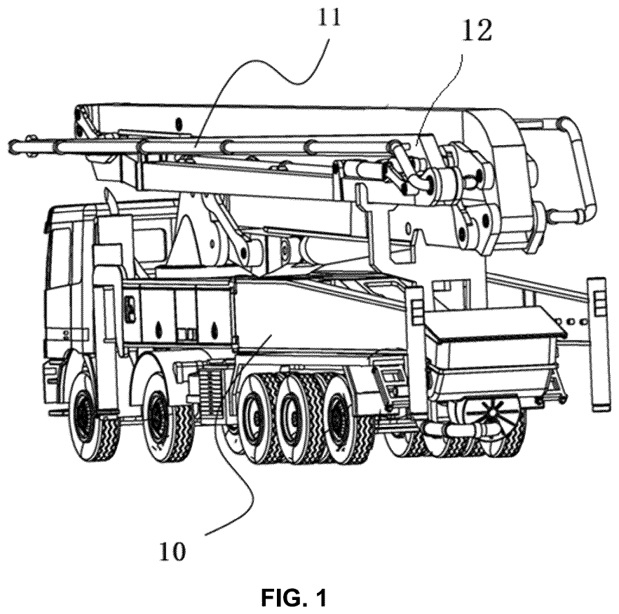

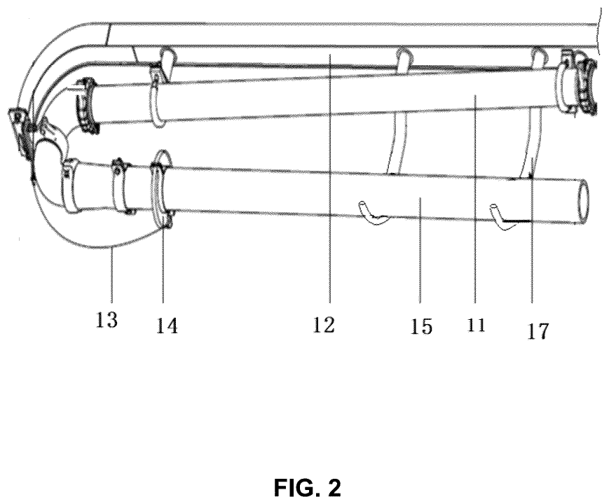

The present disclosure relates to a distributing boom for concrete pumping equipment. The concrete pumping equipment includes a stationary concrete pump and a movable concrete pump truck. The concrete pump truck is provided with a distributing boom, and a concrete conveying pipe is manufactured onto a bracket of the distributing boom. As shown in FIGS. 1 and 2, a concrete pump truck 10 is provided with a concrete distributing boom 12, and a concrete conveying pipe 11 is carried by a bracket 17 on the concrete distributing boom 12, and the concrete conveying pipe 11 includes a hose 15 located at a tail end of the conveying pipe. The bracket 17 is made of a multilayer composite tube composed of at least two alloy layers.

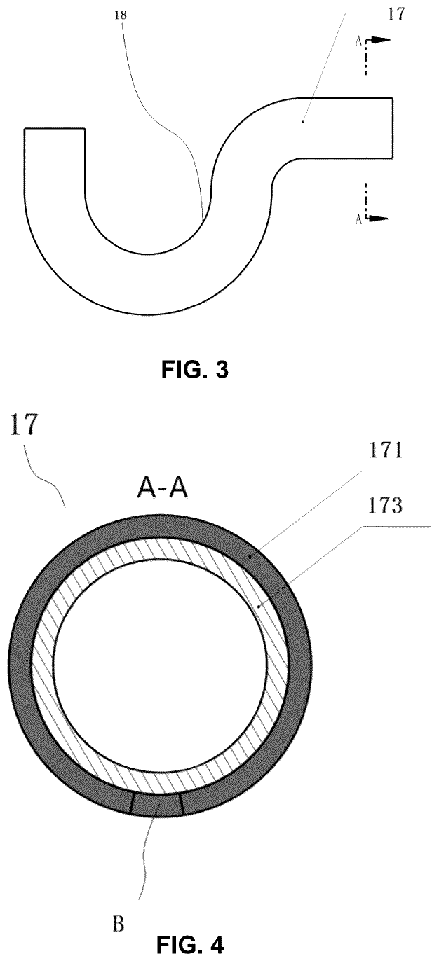

In some embodiments of the present disclosure, referring to FIG. 3 which shows the bracket 17 of the concrete distributing boom 12, the bracket 17 has an open accommodating portion 18. The open accommodating portion 18 is shaped to accommodate the hose 15 therein and to ensure that the hose 15 can be conveniently and frequently taken down from and placed back to the bracket 17 during operation of the concrete pumping truck 10. The shape of the open accommodating portion 18 may be any concave shape, such as a C-shape, a rectangle, or the like, and may also be any other suitable shape as long as it is convenient for taking the hose 15.

The multilayer composite tube of the bracket 17 is composed of at least two layers of aluminum alloy. Of the at least two layers of alloy, an outermost layer of aluminum alloy 171 has higher abrasion resistance, and an innermost layer of aluminum alloy 173 has greater rigidity. In this way, the abrasion resistance and load-carrying property of the bracket 17 are improved. It reduces abrasion of the surface of the bracket 17 due to frequently taking the hose 15 at the tail end of the conveying pipe, and surface rusting resulting from the abrasion, increases the service life of the bracket 17, and thereby also increases the service life of the concrete distributing boom 12.

In some embodiments of the present disclosure, as shown in FIG. 4, the multilayer composite tube of the bracket 17 is composed of two layers of aluminum alloy. The two layers of aluminum alloy include an outermost layer of aluminum alloy 171 and an innermost layer of aluminum alloy 173. Of the two layers, the outermost layer of aluminum alloy 171 has higher abrasion resistance, and the innermost layer of aluminum alloy 173 has greater rigidity. In this way, the abrasion resistance and load bearing property of the bracket 17 are improved.

In some embodiments of the present disclosure, as shown in FIG. 5, the multilayer composite tube of the bracket 17 is composed of three layers of aluminum alloy. The three layers of alloy include an outermost layer of aluminum alloy 171, an intermediate layer of alloy 172, and an innermost layer of aluminum alloy 173, with the intermediate layer of alloy 172 being located between the outermost layer of alloy 171 and the innermost layer of alloy 173. Of the three layers, the outermost layer of aluminum alloy 171 has higher abrasion resistance, the innermost layer of alloy 172 has higher toughness and strength, and the innermost layer of aluminum alloy 173 has greater rigidity. In this way, the abrasion resistance, strength and rigidity of the bracket 17 are improved and its weight is light, and its load-carrying property is improved.

In some embodiments of the present disclosure, the multilayer composite tube of the bracket 17 may be composed of more than three layers of alloy, and differs from the two embodiments of FIGS. 4 and 5 in that an additional intermediate layer of aluminum alloy is added. The additional intermediate layer of aluminum alloy may function to improve properties such as strength, rigidity, or toughness.

In some embodiments of the present disclosure, the density of each of at least two layers of aluminum alloy of the multilayer composite tube decreases sequentially along a radial direction from outside to inside, so that the weight of the bracket is lighter relative to a steel bracket and an all-aluminum-alloy bracket while ensuring good abrasion resistance and load-carrying property of the bracket.

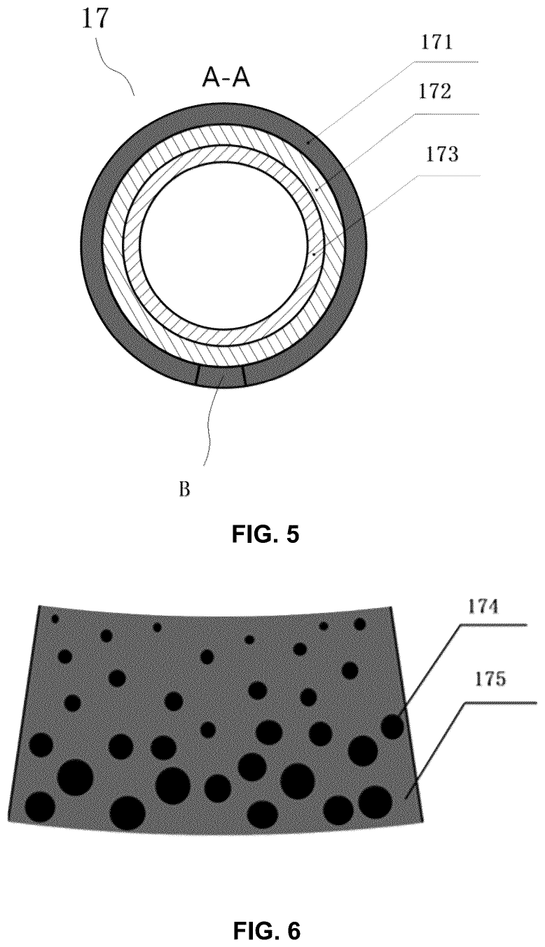

In some embodiments of the present disclosure, as shown in FIG. 6, the outermost layer of aluminum alloy 171 contains abrasion-resistant reinforcing particles 174. The abrasion-resistant reinforcing particles 174 are distributed in the outermost layer of aluminum alloy 171 in such a manner that their sizes progressively increase outwards along a radial direction of the multilayer composite tube. That is, in the outermost layer of aluminum alloy 171, the closer to the inner side, the smaller the sizes of the abrasion-resistant reinforcing particles 174; and the closer to the outer side, the larger the sizes of the abrasion-resistant reinforcing particles 174. Large-size abrasion-resistant reinforcing particles are arranged close to the outer side, which is conducive to improving the abrasion-resistant property of the bracket 17.

In some embodiments of the present disclosure, a combination of sizes of the abrasion-resistant reinforcing particles 174 includes a first diameter ranging between 12-18 μm, a second diameter ranging between 24-36 μm, and a third diameter ranging between 40-60 μm. For example, the first diameter is about 15 μm, the second diameter is about 30 μm, and the third diameter is about 50 μm. In this way, the abrasion-resistant reinforcing particles 174 in the outermost layer of aluminum alloy 171 are distributed with three progressively increasing sizes from inside to outside, which improves the abrasion resistance of the outermost layer of aluminum alloy 174.

In some embodiments of the present disclosure, the outermost layer of aluminum alloy 171 contains abrasion-resistant reinforcing particles 174. In the outermost layer of aluminum alloy 171, the abrasion-resistant reinforcing particles 174 are distributed in the outermost layer of aluminum alloy 171 in a manner of distributing more densely on the outer side than on the inner side. That is, the density of the abrasion-resistant reinforcing particles 174 in an outer side region is greater than that in an inner side region. The greater density of the abrasion-resistant reinforcing particles 174 in the outer side region is conducive to improving the abrasion resistance of the bracket 17, and the smaller density of the abrasion-resistant reinforcing particles 174 in the inner side region means that there is more matrix metal in the alloy, which facilitates better metallurgical bonding of the outermost layer of aluminum alloy 171 with the innermost layer of aluminum alloy 173 or the intermediate layer of aluminum alloy 172. In some embodiments of the present disclosure, the sizes of the abrasion-resistant reinforcing particles 174 may be substantially the same in the outermost layer of aluminum alloy 171.

In some embodiments of the present disclosure, both the multilayer composite tube of the bracket 17 and the concrete distributing boom 12 are made of aluminum alloy. The bracket may be integrally connected to the concrete distributing boom 12 by welding, which achieves good bonding strength between the bracket 17 and the concrete distributing boom 12, thereby improving the load-bearing performance and service life of the concrete distributing boom 12, and facilitating the concrete conveying pipe 11 pumping concrete to a higher position, without the problems of potential difference between different matrix metals, susceptibility to electrochemical corrosion, and poor welding quality.

In some embodiments of the present disclosure, an aluminum alloy matrix of the outermost layer of aluminum alloy 171 is a ZL104 alloy, and material components of the outermost aluminum alloy are Al (89.90 wt %), Si (9.24 wt %), Mg (0.54 wt %), Fe (0.22 wt %), Ni (0.08 wt %), Mg (0.007 wt %), and impurities (the balance); the material of the abrasion-resistant reinforcing particles 174 includes carbide, nitride or oxide, the carbide including SiC, the nitride including TiN and Si3N4, and the oxide including Al2O3; and a combination of particle sizes of the abrasion-resistant reinforcing particles 174 and their proportions by weight are as follows: a diameter of about 15 μm (33.33 wt %), a diameter of about 30 μm (33.33 wt %), and a diameter of about 50 μm (33.33 wt %). Material components of the innermost layer of aluminum alloy 173 are Cu (3.05 wt %), Li (1.45 wt %), Mg (0.50 wt %), Ag (0.35 wt %), Zn (0.25 wt %), Zr (0.12 wt %), Fe (0.05 wt %), Ti (0.05 wt %), and Al (the balance). Material components of the intermediate layer of alloy 172 are Al (92.25 wt %), Cu (4.50 wt %), Mg (0.35 wt %), Ti (0.25 wt %), Mn (0.82 wt %), and impurities (the balance). As compared with a steel bracket, the weight of the aluminum alloy bracket 17 is reduced by at least 50%. As compared with a bracket formed by welding together ordinary aluminum alloy bent tubes of the same size, the weight is reduced by at least 20%, the load-bearing performance is improved by at least 50%, the surface abrasion resistance is improved by at least 30%, and the rigidity is improved by at least 30%.

As shown in FIGS. 1 and 2, the present disclosure also provides concrete pumping equipment 10. The concrete pumping equipment 10 is a stationary concrete pump or a mobile concrete pump truck. The concrete pumping equipment 10 includes a concrete distributing boom 12, and a hose 15 located at a tail end of a concrete conveying pipe 11, the hose 15 being supported on a bracket 17 of the concrete distributing boom 12.

The present disclosure also provides a method for manufacturing a bracket 17 of a concrete distributing boom 12, including:
centrifugally casting a tube blank 24, including continuously casting at least two layers of alloy successively by a centrifugal casting process to form a multilayer composite tube blank 24, the at least two layers of alloy including an outermost layer of aluminum alloy 171 having high abrasion resistance and an innermost layer of aluminum alloy 173 having high rigidity;
transferring the tube blank 24, including after the centrifugal casting of the tube blank 24 is completed, transferring the tube blank 24 from a station for performing centrifugal casting to a station for performing rotary extrusion so as to rotationally extrude the tube blank 24 to obtain the bracket 17;
rotationally extruding the tube blank 24, including rotationally extruding the tube blank 24 to obtain the bracket 17;

The bracket 17 is obtained by continuously performing the steps of centrifugally casting the tube blank, transferring the tube blank 24, and rotationally extruding the tube blank 24 successively. The above steps are performed continuously and without interruption, thereby increasing processing efficiency and reducing heat transfer loss between the steps. Moreover, the at least two layers of alloy are cast successively and continuously by a centrifugal casting process, so that the bonding strength between the at least two layers of alloy is good.

The present disclosure provides equipment for manufacturing a bracket 17 of a concrete distributing boom 12, the equipment including a centrifugal casting device 200 and a rotary extrusion device 20.

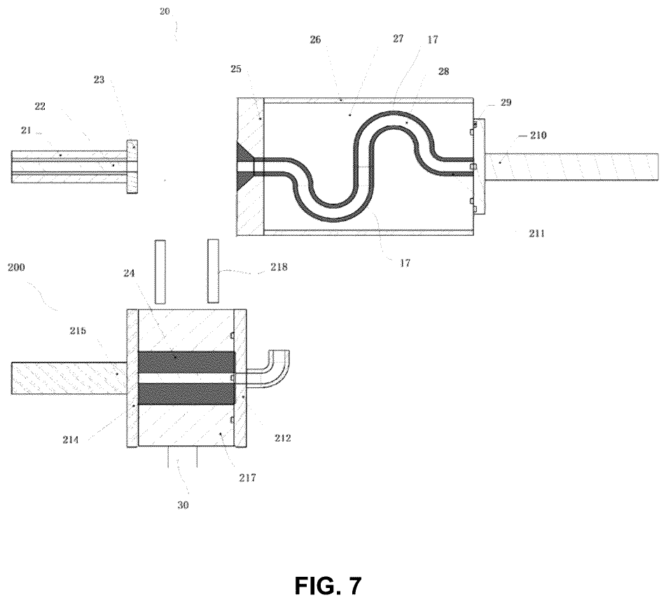

As shown in FIG. 7, the centrifugal casting device 200 includes a centrifugal casting die 217 having a cavity therein, a casting end cap 214 separably mounted at one end of the centrifugal casting die 217, a centrifugal driving device 215 mounted to the casting end cap 214 and configured to drive the centrifugal casting die 217 to rotate, and a pouring end cap 212 separably mounted at the other end of the centrifugal casting die 217. The casting end cap 212 is provided with a pouring gate so that molten alloy enters a cavity of the centrifugal casting die 217 through the pouring gate.

The centrifugal casting die 217 is movable to switch between a station for performing centrifugal casting and a station for performing rotary extrusion. When the centrifugal casting die 217 is located in the station for performing centrifugal casting, the centrifugal casting die 217 is communicated with the pouring gate of the pouring end cap 212 so as to form, by a centrifugal casting process, a tube blank 24 having at least two layers of alloy, in the cavity of the centrifugal casting die 217.

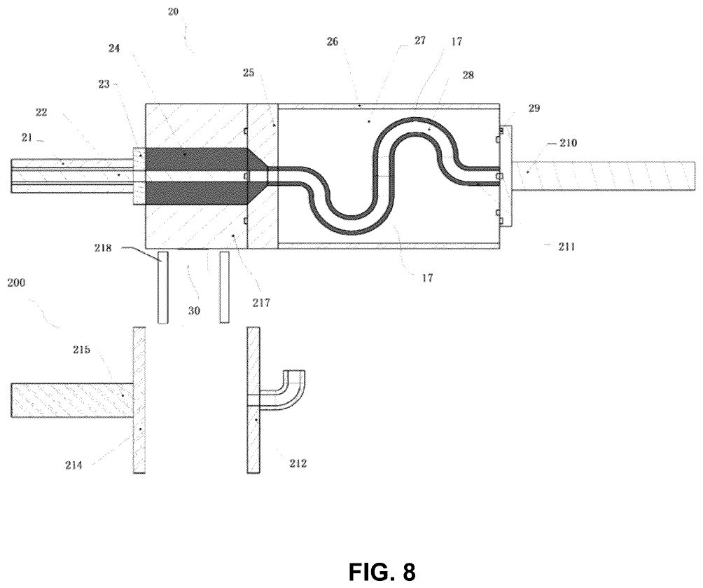

As shown in FIG. 8, the rotary extrusion device 20 includes an extrusion rod 21 with an extrusion pad 23, a piercing needle 22 located within the extrusion rod 21, a bracket forming die 27, an extrusion die mouth 25 located at one end of the bracket forming die 27 and communicated with a cavity of the bracket forming die 27, a forming core die 28 within the cavity of the bracket forming die 27, and a rotary ejector rod 210 located at the other end of the bracket forming die 27 and blocking a cavity port.

After the tube blank 24 is cast in the centrifugal casting device 200, the casting end cap 214 and the pouring end cap 212 are separated from the centrifugal casting die 217, and the centrifugal casting die 217 is moved from the station for performing centrifugal casting shown in FIG. 7 to the station for performing rotary extrusion as shown in FIG. 8, such that the cavity of the centrifugal casting die 217 is in communication with the extrusion die mouth 25 to enable the tube blank 24 in the cavity of the centrifugal casting die 217 to be extruded into the bracket forming die 27 through the extrusion die mouth 25 to form the bracket 17.

In some embodiments of the present disclosure, the equipment for manufacturing the bracket 17 of the concrete distributing boom 12 includes a rail 218. The rail 218 extends between the centrifugal casting device 200 and the rotary extrusion device 20, and the centrifugal casting die 217 is movable along the rail 218 to switch between the station for performing centrifugal casting and the station for performing rotary extrusion.

In some embodiments of the present disclosure, as shown in FIGS. 7 and 8, the equipment for manufacturing the bracket 17 of the concrete distributing boom 12 includes a controller 30. The controller 30 may be mounted on the centrifugal casting device 217, and may also be mounted on other component or location of the equipment. The controller 30 is in signal communication with the centrifugal casting device 200 and the rotary extrusion device 20 in order to receive operating status information of the centrifugal casting device 200 and the rotary extrusion device 20 and to send instructions directing the centrifugal casting device 200 and rotary extrusion device 20 to perform operations. The instructions may be sent directly to the centrifugal casting device 200 and the rotary extrusion device 20, and may also be sent to another device to perform operations on the centrifugal casting device 200 and the rotary extrusion device 20, so as to perform at least one of the following operations:
in response to the centrifugal casting device 200 completing preparation of the tube blank 24, the controller 30 immediately sends an instruction to drive the centrifugal casting device 217 to move from the station for performing centrifugal casting toward the station for performing rotary extrusion;
in response to the centrifugal casting device 217 arriving at the station for performing rotary extrusion, the controller 30 sends an instruction directing the rotary extrusion device 20 to perform extrusion of the tube blank 24; and
in response to the rotary extrusion device 20 completing extrusion of the tube blank 24, the controller 30 sends an instruction to drive the centrifugal casting device 217 to move toward the station for performing centrifugal casting.

Using the controller 30, the process from centrifugal casting to extrusion molding is executed continuously and without interruption, which improves overall processing efficiency.

In some embodiments of the present disclosure, manufacturing the multilayer composite tube blank 24 having at least two layers of alloy by the centrifugal casting device 200 includes the following steps:

First, an outermost layer of aluminum alloy 171 is prepared, including agitating an aluminum alloy matrix, and successively adding abrasion-resistant reinforcing particles 174 of various sizes, wherein a rotational speed of agitating the aluminum alloy matrix when small-size abrasion-resistant reinforcing particles 174 are added is less than a rotational speed of agitating the aluminum alloy matrix when large-size abrasion-resistant reinforcing particles 174 are added. Using a combination of abrasion-resistant reinforcing particles 174 of three sizes as an example, after matrix alloy is melted in a furnace, the matrix alloy is stirred at a first rotational speed and abrasion-resistant reinforcing particles 174 of a first diameter are added, then the matrix alloy is stirred at a second rotational speed and abrasion-resistant reinforcing particles 174 of a second diameter are added, and subsequently the matrix alloy is stirred at a third rotational speed and abrasion-resistant reinforcing particles 174 of a third diameter are added. The first diameter is smaller than the second diameter is smaller than the third diameter, and the first rotational speed is smaller than the second rotational speed is smaller than the third rotational speed. The first diameter ranges between 12-18 μm, the second diameter ranges between 24-36 μm, and the third diameter ranges between 40-60 μm. Optionally, the first diameter is about 15 μm, the second diameter is about 30 μm, and the third diameter is about 50 μm.

The aluminum alloy matrix with the abrasion-resistant reinforcing particles 174 is poured into the cavity of the centrifugal casting device 200, and the outermost layer of aluminum alloy 171 containing the abrasion-resistant reinforcing particles 174 is prepared by a centrifugal casting process.

Once the preparation of the outermost layer of aluminum alloy 171 is completed, a melted aluminum alloy is poured into the cavity of the centrifugal casting device 200, and a second layer of aluminum alloy is cast on the inner side of the highly abrasion-resistant outermost layer of aluminum alloy 171 by a centrifugal casting process. The second layer of aluminum alloy has high rigidity or high strength and toughness. Since the abrasion-resistant reinforcing particles 174 are distributed in the outermost layer of aluminum alloy 171 in a manner of distributing more densely on the outer side than on the inner side, when the inner side of the outermost layer of aluminum alloy 171 containing fewer abrasion-resistant reinforcing particles 174 and more aluminum alloy matrix components is bonded with the second layer of the aluminum alloy, the composition of the inner side of the outermost layer of aluminum alloy 171 is closer to the composition of the second layer of the aluminum alloy, which improves the bonding strength between the multiple layers of alloy. In the case where the second layer of aluminum alloy has high rigidity, the second layer of aluminum alloy can be used as an innermost layer of aluminum alloy 173, which is conducive to reducing the amount of deformation that occurs when the bracket 17 is subjected to a load, and reducing jiggling of the hose 15.

Once the preparation of the high-strength-and-toughness second layer of aluminum alloy 172 is completed, a melted high-rigidity alloy material is poured into the cavity of the centrifugal casting device 200, and a high-rigidity third layer of aluminum alloy 173 is cast on the inner side of the high-strength-and-toughness second layer of aluminum alloy 172 by a centrifugal casting process. The high-strength-and-toughness second aluminum alloy 172 serves as an intermediate layer of alloy, which increases the overall strength and toughness of the multilayer composite tube, thereby increasing the load-carrying capacity of the multilayer composite tube, and the high-rigidity third layer of aluminum alloy 173 may serve as an innermost layer of aluminum alloy, which is conducive to reducing the amount of deformation that occurs when the bracket 17 is subjected to a load, and reducing jiggling of the hose 15.

In centrifugal casting of the multiple layers of alloy, since it ensures that as soon as preparation of a previous layer of alloy is finished, a melted alloy material is immediately poured in and centrifugal casting of a following layer of alloy starts on the inner side of the previous layer of alloy, heat loss between the preparation of the previous layer of alloy and the following layer of alloy is avoided, and the efficiency of heat transfer between the various processes is improved, and since the centrifugal casting of the following layer of alloy is carried out immediately after the centrifugal casting of the previous layer of alloy, the bonding strength between multiple layers of alloy is improved.

In some embodiments of the present disclosure, operation steps of the rotary extrusion device 20 are described: as shown in FIGS. 7 and 8, once the centrifugal casting device 200 completes the preparation of the tube blank 24, the centrifugal casting die 217 with the tube blank 24 is immediately moved into the rotary extrusion device 20 and placed in place, and the extrusion rod 21, the piercing needle 22 and the extrusion pad 23 are arranged in place on one side of the centrifugal casting die 217, and the extrusion die mouth 25, the heating device 26, the bracket forming die 27, the forming core die 28 and the rotary ejector rod 210 are arranged in place on the other side of the centrifugal casting die 217, wherein the piercing needle 22 is moved until it abuts against the forming core die 28, two halves of the bracket forming die 27 are closed, and the heating device 26 is mounted on an outer periphery of the bracket forming die 27. The heating device 26 heats the centrifugal casting die 217, the extrusion die mouth 25, and the bracket forming die 27; the extrusion rod 21, the rotary ejector rod 210, and the extrusion pad 23 begin to work; the rotary ejector rod 210, under the action of a sustaining pressure (the pressure is in the range of 5-50 MPa, for example, being 15 MPa), causes the extrusion die mouth 25 and the bracket forming die 27 to rotate with a uniform speed (the rotational speed is in the range of 1-30 RPM, for example, being 6 RPM) to implement rotary extrusion of the composite tube blank 24; subsequently, the extruded composite tube blank 24 enters the bracket forming die 27, and a tube blank 28 is formed around the forming core die 28 in the cavity. The extrusion rod 21 returns after reaching a predetermined stroke, and a heating system is turned off; the bracket forming die 27 is opened, and after aging treatment on the formed bracket, the formed bracket is cut to obtain a plurality of brackets 17. By rotationally extruding the tube blank 24 under the condition of heating, good metallurgical bonding between the multiple layers of alloy is achieved under a hot-press rotational coupling effect.

Since the centrifugal casting die 217 is movable and can be switched between the station for performing centrifugal casting in the centrifugal casting device 200 and the station for performing rotary extrusion in the rotary extrusion device 20, the operations of the centrifugal casting device 200 and the rotary extrusion device 20 can be performed continuously and without interruption. As the centrifugal casting die 217 is shared by the centrifugal casting device 200 and the rotary extrusion device 20, the continuity between the centrifugal casting and the rotary extrusion processes, and the work efficiency are improved.

Described above are only exemplary embodiments of the present disclosure, which are not intended to limit the present disclosure, and all modifications, equivalent substitutions and improvements made within the spirit and principle of the present disclosure should be encompassed within the protection scope of the present disclosure.

1. A concrete distributing boom (12) being provided with a bracket (17), the bracket (17) being configured to support a hose (15) at a tail end of a concrete conveying pipe (11), the bracket (17) being formed by a multilayer composite tube made of at least two layers of aluminum alloy arranged in a stacked manner; the at least two layers of aluminum alloy comprising an outermost layer of aluminum alloy (171) and an innermost layer of aluminum alloy (173), wherein of the at least two layers of aluminum alloy, the outermost layer of aluminum alloy (171) is more resistant to abrasion, and the innermost layer of aluminum alloy (173) is more rigid.

2. The concrete distributing boom (12) according to claim 1, wherein the at least two layers of aluminum alloy further comprise an intermediate layer of aluminum alloy (172) located between the innermost layer of aluminum alloy (173) and the outermost layer of aluminum alloy (171), the intermediate layer of aluminum alloy (172) having greater strength and toughness relative to the innermost layer of aluminum alloy (173) and the outermost layer of aluminum alloy (171).

3. The concrete distributing boom (12) according to claim 1, wherein the innermost layer of aluminum alloy (173) has a density less than that of the outermost layer of aluminum alloy (171), or the intermediate layer of aluminum alloy (172) has a density less than that of the outermost layer of aluminum alloy (171) but greater than that of the innermost layer of aluminum alloy (173).

4. The concrete distributing boom (12) according to claim 2, wherein the densities of the at least two layers of aluminum alloy decrease sequentially from outside to inside.

5. The concrete distributing boom according to claim 1, wherein the concrete distributing boom (12) is made of aluminum alloy and is integrally connected with the bracket (17).

6. The concrete distributing boom (12) according to claim 1, wherein the outermost layer of aluminum alloy (171) contains abrasion-resistant reinforcing particles (174).

7. The concrete distributing boom (12) according to claim 6, wherein the abrasion-resistant reinforcing particles (174) are distributed in the outermost layer of aluminum alloy (171) in such a manner that their sizes progressively increase outwards along a radial direction.

8. The concrete distributing boom (12) according to claim 6, wherein the abrasion-resistant reinforcing particles (174) are distributed in the outermost layer of aluminum alloy (171) in a manner of distributing more densely on the outer side than on the inner side.

9. The concrete distributing boom (12) according to claim 6, wherein a combination of sizes of the abrasion-resistant reinforcing particles (174) comprises a first diameter ranging between 12-18 μm, a second diameter ranging between 24-36 μm, and a third diameter ranging between 40-60 μm.

10. The concrete distributing boom (12) according to claim 9, wherein the first diameter is about 15 μm, the second diameter is about 30 μm, and the third diameter is about 50 μm.

11. A concrete pumping equipment (10), configured to be a stationary concrete pump or a mobile concrete pump truck, which comprises a hose (15) located at a tail end of a concrete conveying pipe (11), and the concrete distributing boom (12) as claimed in claim 1.

12. A method for manufacturing a bracket (17) of a concrete distributing boom, the bracket (17) being configured to support a hose (15) located at a tail end of a conveying pipe (11) of concrete pumping equipment (10), wherein the method comprises the following steps:
centrifugally casting a tube blank, comprising preparing a multilayer composite tube blank (24) having at least two layers of alloy by a centrifugal casting process, the at least two layers of alloy comprising an outermost layer of aluminum alloy (171) having high abrasion resistance and an innermost layer of aluminum alloy (173) having high rigidity;
transferring the tube blank, comprising transferring the tube blank (24) from a station for performing centrifugal casting to a station for performing rotary extrusion;
extrusion molding a bracket, comprising performing rotary extrusion on the tube blank (24) to obtain the bracket (17); and
continuously performing the steps of centrifugally casting the tube blank, transferring the tube blank, and extrusion molding the bracket, successively.

13. The method according to claim 12, wherein the step of transferring the tube blank comprises transferring the tube blank (24) from the station for performing centrifugal casting to the station for performing rotary extrusion by moving a centrifugal casting die (217); in the station for performing centrifugal casting, the tube blank (24) is centrifugally cast in a cavity of the centrifugal casting die (217); and in the station for performing rotary extrusion, the tube blank (24) in the cavity of the centrifugal casting die (217) is rotationally extruded.

14. The method according to claim 12, wherein the step of centrifugally casting the tube blank comprises:
providing abrasion-resistant reinforcing particles (174) of various sizes;
heating and melting an aluminum alloy matrix;
agitating the aluminum alloy matrix, and successively adding the abrasion-resistant reinforcing particles (174) of various sizes, wherein a rotational speed of agitating the aluminum alloy matrix when small-size abrasion-resistant reinforcing particles (174) are added is less than a rotational speed of agitating the aluminum alloy matrix when large-size abrasion-resistant reinforcing particles (174) are added; and
pouring the aluminum alloy matrix with the abrasion-resistant reinforcing particles (174) into a cavity of a centrifugal casting device, and preparing an outermost layer of aluminum alloy (171) containing the abrasion-resistant reinforcing particles (174) by a centrifugal casting process.

15. The method according to claim 14, wherein the various sizes of the abrasion-resistant reinforcing particles (174) comprise a first diameter between 12-18 μm, a second diameter between 24-36 μm, and a third diameter between 40-60 μm.

16. The method according to claim 15, wherein the first diameter is about 15 μm, the second diameter is about 30 μm, and the third diameter is about 50 μm.

17. The method according to claim 12, wherein in the step of centrifugal casting the tube blank, after the highly abrasion-resistant outermost layer of aluminum alloy (171) is prepared, melted aluminum alloy is poured into the cavity of the centrifugal casting device, and a second layer of aluminum alloy (172; 173) is cast on the inner side of the highly abrasion-resistant outermost layer of aluminum alloy (171) by a centrifugal casting process, the second layer of aluminum alloy (172; 173) having higher rigidity or having higher strength and toughness than the outermost layer of aluminum alloy (171).

18. The method according to claim 17, wherein in the step of centrifugal casting the tube blank, after the second layer of aluminum alloy (172) with higher strength and toughness is prepared, a melted high-rigidity alloy material is poured into the cavity of the centrifugal casting device, and a third layer of aluminum alloy (173) is cast on the inner side of the high-strength-and-toughness second layer of aluminum alloy (172) by a centrifugal casting process, the third layer of aluminum alloy (173) having higher rigidity than the highly abrasion-resistant outermost layer of aluminum alloy (171) and the high-strength-and-toughness second layer of aluminum alloy (172).

19. The method according to claim 17, wherein in a radial direction of the tube blank (24), the densities of the layers of aluminum alloy decrease sequentially from outside to inside.

20. An equipment for manufacturing a concrete distributing boom bracket (17), comprising:
a centrifugal casting device (200) comprising a centrifugal casting die (217) having a cavity therein; and
a rotary extrusion device (20) configured to extrude a tube blank (24) to form the bracket (17), and comprising an extrusion die mouth (25) and a bracket forming die (27) which are communicated with each other,
wherein the centrifugal casting die (217) is movable to switch between a station for performing centrifugal casting and a station for performing rotary extrusion, wherein when the centrifugal casting die (217) is located in the station for performing centrifugal casting, the tube blank (24) having at least two layers of alloy is centrifugally casted in the cavity of the centrifugal casting die (217), and when the centrifugal casting die (217) is located in the station for performing rotary extrusion, the cavity of the centrifugal casting die (217) is communicated with the extrusion die mouth (25), so that the tube blank (24) in the cavity of the centrifugal casting die (217) is rotationally extruded into the bracket forming die (27) through the extrusion die mouth (25) to form the bracket (17).

21. The equipment according to claim 20, further comprising a rail (218), the rail (218) being located between the centrifugal casting device (200) and the rotary extrusion device (20), the centrifugal casting die (217) being movable along the rail (218) to switch between the station for performing centrifugal casting and the station for performing rotary extrusion.

22. The equipment according to claim 20, wherein the rotary extrusion device (20) comprises a heating device (26) for heating the rotary extrusion device (20).

23. The equipment according to claim 20, further comprising a controller (30), the controller (30) being configured to receive operating status information of the centrifugal casting device (200) and the rotary extrusion device (20) and to send instructions directing the centrifugal casting device (200) and rotary extrusion device (20) to perform operations, and the controller (30) being configured to perform at least one of the following operations:
in response to completing preparation of the tube blank (24) having at least two layers of alloy, sending an instruction to drive the centrifugal casting die (217) to move toward the station for performing rotary extrusion; and
in response to the centrifugal casting die (217) arriving at the station for performing rotary extrusion, sending an instruction directing the rotary extrusion device (20) to perform extrusion of the tube blank (24); and
in response to the end of extrusion of the tube blank (24) by the rotary extrusion device (20), sending an instruction to drive the centrifugal casting die (217) to move toward the station for performing centrifugal casting.
